(19) United States
(12) Patent Application Publication
(10) Pub. No.: US 2009/0056570 A1
(43) Pub. Date: Mar. 5, 2009

(54) DEVICE FOR PRINTING FLAT WORK PIECES

(75) Inventors: Sascha Lammle, Oberndorf (DE); Michael Poitinger, Baiersbronn (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ROBERT BURKLE GMBH, Freudenstadt (DE)

(21) Appl. No.: 11/847,462

(22) Filed: Aug. 30, 2007

(51) Int. Cl. B41L 13/04; B23Q 15/00

(52) U.S. Cl. 101/126; 226/45

(57) ABSTRACT

A device for printing flat work pieces having a transportation device for the work pieces and having at least one printing device, in which an inking roll rolls on the work pieces transported through the printing device and thereby applies a print image to a surface of the work piece, with the transportation device being provided with a lateral guide for the work pieces. The lateral guide has sections that are individually adjustable via actuators between the neutral position and a test position.

### BACKGROUND

The invention relates to a device for printing flat work pieces with a transportation device for the work pieces and at least one printing device, in which an inking roll rolls on the work pieces transported through the printing device and thereby applies a print image onto the surface of the work piece. The transportation device is provided with a lateral guide for the work pieces, which are transported through the printing device contacting this guide. The inking roll can here be embodied as a printing cylinder or a transfer roll for transferring ink from a printing cylinder, for example an engraved cylinder, to the surface of the work piece, while usually a counter roll being provided, which cooperating with the inking roll forms a printing nip. In multi-color printing in a generic device, several printing devices are arranged sequentially, with the work pieces successively passing through them.

In particular in order to give wooden particle board panels the appearance of real wood, due to the advantageous costs in comparison to real wood veneer or foil coating, increasingly printed images of decors and grain is printed directly onto the wooden particle board panels. For a quality appearance as good as possible a simple monochromatic print is insufficient, though. It is rather desirable to apply the grain or the décor in a multi-color printing process onto the construction panel. This is the case not only in wooden construction panels. Applications for other materials, which can be improved in their quality by a surface print, such as for example stone or imitation leather, can be upgraded by a multi-color print.

In particular for a qualitative high-value multi-color print it is however mandatory for the individual print images on the work piece to be positioned within very narrow tolerances, typically in the range of ±0.1 mm. Only in this way is a visual quality comparable to conventional foil coating achievable. These requirements are much harder to comply with in the present flat work pieces than in machines for paper or foils. Due to the fact that the present flat work pieces do not travel continuously through the printing machine like a printing web in a printing process according to the example of paper web printing machines, it is generally impossible due to the rigidity of the present flat work pieces.

A device of the type mentioned at the outset, which addresses the above-described problem with excellent results, is known from DE 103 33 626 A1. Here, among other things, a print image is automatically evaluated by an image processing device if the image position as well as the image length are within or outside the predetermined tolerances. The results provided effect the drives of the transportation device and/or the drives of the cylinders cooperating in the print in order to influence the image location and/or the image length, if necessary, targeting smaller tolerances. This represents a control loop performing corrections during the production, in particular by accelerating or slowing individual or all cylinders cooperating in the print and/or the transportation device.

When printing work pieces with grain it is frequently problematic, though, to detect the exact coincidence of the print images and/or to determine in which direction the correction is to occur in order to improve a bad print image; by their nature, grains are intentionally embodied in an irregular pattern, which particularly aggravates to a large extent any automatic detection of the image position via image processing devices. Help may be provided through the use of separate image location markers, for example in form of fitting markers or colored signals, which are applied in addition to the print image itself onto the surface of work piece and allow an automatic evaluation of the respective position of the print image with great precision, and in case of an appropriate number of image location markers also the image length. In case of a full-surface print of surfaces of work pieces with decors or grains the use of such image location markers is impossible, of course, in the continuous production process. Rather, repeated test runs have to be performed in order to test the exact position of the print images. The production must therefore be interrupted.

### SUMMARY

The present invention is therefore based on the object of providing an automatic monitoring and, if necessary, adjustment of the precise print image positioning even during the production process when the work pieces are printed over their entire surface.

This object is attained by a device according to the invention. Preferred embodiments of said device are described in detail below.

The device for printing flat work pieces according to the present invention, in which the work piece is transported via a transportation device with a lateral guide through the printing device, in which a inking roll applies a print image to the surface of the work piece is provided according to the invention with a lateral guide, which is sectionally adjustable by a motor between a neutral position and a test position. By this measure it is possible to use a regular work piece from the production as a sample for testing the positioning of the print image and the image length, namely simply by adjusting via a motor the lateral guide at least at the section, in which the work piece is presently located, so that its lateral edge is not transported along the neutral position of the lateral guide but along a test position, i.e. laterally off-set in reference to the normal position. This results even in a full-surface print on the surface of the work piece in an edge not printed with the image itself, on said edge then image markers, such as fitting markers or colored signals can be applied and clearly recognized by the detection device at the end of the device. The motorized adjustment of the lateral guide sections according to the invention ensures here that the sections are exactly adjusted by the same distance each and that thereafter the neutral position is also returned to with the same precision. Otherwise the result of the detection of the image position markers is hardly useful. A motorized adjustment covers all measures, which adjust the respective sections of the lateral guide other than manually, such as e.g., an adjustment via electromotive, hydraulic, or pneumatic drives.

The invention can also be used particularly beneficial during the production process, namely by providing a control for the lateral guide, which sectionally adjusts the lateral guide, if necessary, such that a certain work piece of a sequence of work pieces located in the transportation device successively contacts the sections of the lateral guide adjusted in the test position and is thereby, laterally off-set, transported through the printing device, while the other work pieces contact the sections of the lateral guide in the neutral position and therefore the production continues uninterrupted. The control can then be programmed, for example, that every one-hundredth work piece passes through the printing device laterally off-set as a sample or passes through several printing devices in order to continuously monitor the production quality and to engage in an adjusting process, if necessary.

As already mentioned, it is advantageous for the device according to the invention that the printing device prints image location markers to the lateral edge exceeding beyond the neutral position of the lateral guide, the test edge of the surface of the work piece laterally off-set in the test position, while after the printing device a detection device is arranged to detect the image position markers.

Here, it is beneficial for the detection device to cooperate with the control system such that the control system, if necessary, changes the neutral position of the lateral guide to correct lateral shifts of the print image.

The detection device can alternatively cooperate with the control system such that it axially displaces the print cylinder, if necessary, in order to correct lateral displacements of the print image. Alternatively or in addition to the axial displacement of the print cylinder the entire printing device or individual components thereof can be laterally displaced.

As known per se, the detection device is provided with an optic sensor, particularly embodied as a digital camera. Using such a digital camera, print images and fitting markers can not only be detected according to their structure but also according to their color digitally analyzed.

Based on the differences in height, which the materials of the present type usually show, it is here advantageous when the optic sensor is arranged height-adjustable so that the surface of the printed work piece is always reliably located at the focal point of the optic sensor.

It is particularly preferred, in particular in multi-color print with several printing devices, that a control panel is provided in the device according to the invention, which controls the drives of the printing devices, the drives of the transportation device, and the drives of the lateral guides and also regulates them, namely depending on the signals of the detection device. Here, for example a front and a rear colored signals can be applied on the test edge of a work piece transported through the device in the test position, by which each fitting marker is printed by one printing device each. The detection device then can optically control for the respective correct position of the individual fitting markers accordingly and thereby determine the correct positioning of the print image in the transportation direction, the position of the print image in the lateral direction, as well as by comparing the two colored signals recognize the length of the print image. When the values are outside the predetermined tolerance the control panel then regulates the respective drives such that the image position and/or the length of the print image are brought into the tolerance range. This may occur, as generally known from DE 103 33 626 A1, by accelerating or slowing one or more drives in the printing device and/or by accelerating or slowing the transportation device in front of the printing device and/or by changing the neutral position of the lateral guide and/or by an axial adjustment of the cylinders of the printing device cooperating in the print. A correction of the length of the print image can occur by a targeted creation of a slip between the cylinders of the printing device carrying the image or the inking roll and the surface of the work piece.

Finally, additional advantages develop when means are provided to create a transportation power component for the work piece aligned perpendicular in reference to the transportation device and the lateral guide. In this way, a single lateral guide is sufficient and guides at both sides of the transportation path are not necessary. The lateral guide is then a stop, against which the work pieces are automatically pressed, thus resulting in a precise lateral alignment of the work pieces. Such means can be embodied as a diagonal roller conveyer, or be provided as a slight off-set of the inking roll in reference to a counter roll of the printing nip in the horizontal axial position or in a slight diagonal off-set position in reference to the traveling direction.

With the invention it is also possible to use the corrective methods known from DE 103 33 626 A1, in particular for a multi-colored print on a flat work piece, even when it is to be printed over its entire surface and, based on the irregular print image, such as wood grain, it is difficult to reliably detect displacements of the print image and changes of the length of the print image by an image-processing sensor. Using the invention, during the production individually selected sample work pieces can be printed laterally off-set and be provided with a test edge, allowing the application of fitting markers and color signals.

The positioning of the print image with regard to its start can be performed by sensors in a manner known from DE 103 33 626 A1, which recognizes the front edge of the work piece prior to the respective printing device, which coincides with the position of the repeat pattern in full-surface print and by a targeted acceleration or slowing of the transportation device and/or the print, cylinder keeps the beginning of the print image within very narrow tolerances. Inaccuracies in the length of the print image may vary sometimes due to the pre-printing adjustment of the inking roll and the thickness of the work pieces as well as the usually lack of homogeneity of the surface of the inking roll can be recognized using fitting markers or color signals on the test edge of the sample work pieces by a subsequent detection unit and, via a correction of the trend, be eliminated by creating a targeted slippage between the surface of the work piece and the inking roll and/or between the inking roll and a potentially existing additional print cylinder. Lateral displacements of the print image perhaps recognized by the fitting markers or the colored signals on the test edge of the sample work piece are also eliminated by the correction of the trend using a lateral displacement of the printing cylinder or a change in the neutral position of the lateral guide.

### BRIEF DESCRIPTION OF THE DRAWINGS

An exemplary embodiment of the device according to the invention is described and explained in greater detail using the attached drawings. Shown are:

FIG. 1 is a schematic top view of an exemplary device according to the invention;

FIG. 2 is a top view according to FIG. 1 with an adjustable lateral guide section;

FIG. 3 is a schematic front view of the printing device of the exemplary embodiment according to FIGS. 1 and 2;

FIG. 4 is a view according to FIG. 3, however with a laterally off-set work piece;

FIG. 5 is a top view of a work piece printed as a sample with fitting markers on a test edge;

FIG. 6 is a view of the fitting marker X of FIG. 5;

FIG. 7 is a view of the fitting marker X of FIG. 5 with different print results.

### DETAILED DESCRIPTION OF THE PREFERRED EMBODIMENTS

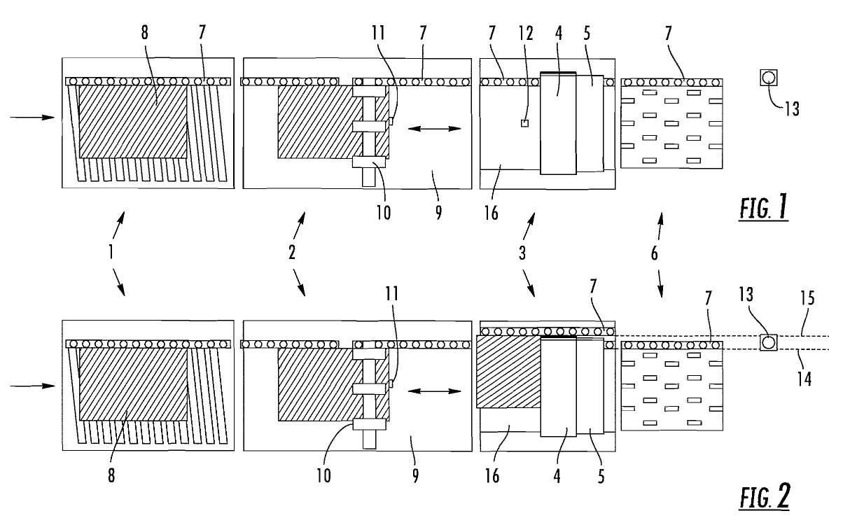

An exemplary embodiment for a device according to the invention shown in FIG. 1 and comprises a diagonal roller conveyer 1, a conveyer drive 2, a printing device 3 with an inking roll 4, and an engraved roll 5 as well as a roller conveyer 6, arranged successively in line and each provided with sections of a lateral guide 7. The lateral guide 7 comprises in the present case a vertically arranged conveyer belt. Generally three to five printing devices are arranged between the printing device 3 shown here and the roller conveyer 6 at the output of the production line in order to apply a multi-colored print on passing work pieces 8. For reasons of a facilitated illustration only one printing device 3 is shown here.

The printing device 3 comprises not only the inking roll 4 and the engraved roll 5; below the inking roll 4, a counter-roll (not shown) is provided to form a printing nip, while a conveyer belt 16 ensures a transportation of the work piece 8, as free from slippage as possible, along the inking roll 4 which rolls over it. In particular work pieces 8 made from wooden material show variations in thickness, which normally prevent any direct print via a print cylinder. For this reason the inking roll 4 provided here is embodied as a transfer roll formed as rubberized steel roll, with the surface of the rubber jacket being cut smoothly. The print image is accordingly transferred from the engraved cylinder 5, which is provided with recesses filled in the inking device (not shown) with ink and subsequently released on to the inking roll 4. During the printing process the inking roll 4 is simultaneously in contact with the engraved cylinder 5 and the surface of the work piece 8, as it accepts the printing image from the engraved cylinder 5 and transfers it to the work piece 8.

The exact 1:1 transfer of the printing image on the surface of the work piece 8 occurs only when no slippage occurs both during the rolling motion of the engraved cylinder 5 on the inking roll 4 and during the rolling motion of the inking roll 4 on the surface of the work piece 8.

By different disturbing influences, such as pre-printing settings of the inking roll 4, the thickness tolerance in the work pieces 8, or a lack of homogeneity of the surface of the inking roll 4 such a slippage can develop, which results in deformations of the print image and simultaneously always results in variations of the length of the print image. In particular in multi-colored print with several printing devices 3 this shows disturbances in the print image, because generally the deformations in the print image do not occur identical in each printing device 3 and thus the individual colors in the print image then no longer precisely coincide.

In order for the work pieces 8 to be printed exactly aligned laterally they are impinged by a lateral force during the transportation through the device, which presses them against the lateral guide 7 and ensures that the work pieces 8 are printed when pressed against the lateral guide 7. In the inlet area of the production line this occurs via the lateral roller conveyer 1, which also allows larger automatic lateral movements of the work pieces 8 for a lateral guide 7, while in a belt conveyer 2, a conveyer belt 9 is combined with above-positioned rolls 10 which apply the lateral force unto the work piece 8. In the printing device 3, a slight off-setting of the inking roll 4 in reference to the counter-roll (not shown) ensures a force component towards the lateral guide 7.

In the present production line the belt conveyer 2 serves to roughly adjust the position of the print image, i.e. it ensures a synchronization of the angular position of the engraved roll 5 to the front edge of the work piece 8. For this purpose a forward motion sensor 11 is provided to recognize the front edge of the work piece 8, while the conveyer belt 9 can be moved back and forth independent from the remaining transportation devices 1, 16, 6. By the conveyer belt 9 slowing, accelerating, or even moving backwards, if necessary, it is ensured that the work piece 8 is transferred to the printing device 3 synchronized in reference to the angular position of the engraved roll 5 so that the beginning of the print image located on the engraved roll 5 and to be transferred to the inking roll 4 approximately coincides with the front edge of the work piece 8. A sensor 12 for the position of the print image in the printing device 3, arranged immediately in front of the inking roll 4, serves for fine-tuning the beginning of the print image in the method known from DE 103 33 626 A1. When the angular position of the engraved roll 5 is not synchronized exactly at the time the front edge of the work piece 8 passes the sensor 12 of the position of the print image for the beginning of the print image exactly coinciding with the front edge of the work piece 8 the conveyer belt 16 is slowed or accelerated and additionally or alternatively the inking roll and the engraved roll 5 are slowed or accelerated in order to ensure an exact accord and thus an repeat pattern at the beginning edge of the work piece 8.

The already discussed distortions of the print image or tolerances in the length of the print image that develop by slippage in the printing device 3 as well as a lateral tolerance of the location of the print image cannot be detected based on the front edge of the work piece 8 so that in this context the forward motion sensor 11 and the sensor 12 of the location of the print image are ineffective. Here, fitting markers, or in case of several printing devices 3, fitting markers combined with colored signals must be applied on the surface of the work piece 8 to allow the detection of variations in the length of the print image as well as the lateral location of the print image. This occurs automatically by a camera 13 arranged at the exit form the device, which can evaluate the fitting markers using digital image processing.

As mentioned at the outset, it is impossible in full-surface printing of the surface of the work pieces 8 to apply fitting markers without considerably disturbing the print image; normally fitting markers located inside the print image are not acceptable to the customer.

Accordingly the lateral guide 7 according to the present invention has sections that can be individually adjusted, which is shown in FIG. 2. Here, a selected sample work piece 8 is laterally off-set and guided through the printing device 3, in which the section of the lateral guide 7 located at the printing device 3 has been laterally displaced out of a neutral position 14 using a motorized drive or actuator into a test position 15. The other sections of the lateral guide 7 remain in the neutral position 14 so that the other work pieces 8 located in the sequence continue to be printed and processed normally. Each time the laterally off-set work piece 8 arrives at a respective section of the lateral guide 7 said section is adjusted to the test position and after passing a respectively laterally displaced work piece 8 is returned to the neutral position 14 so that as a result only a single work piece 8 is guided through the device laterally off-set.

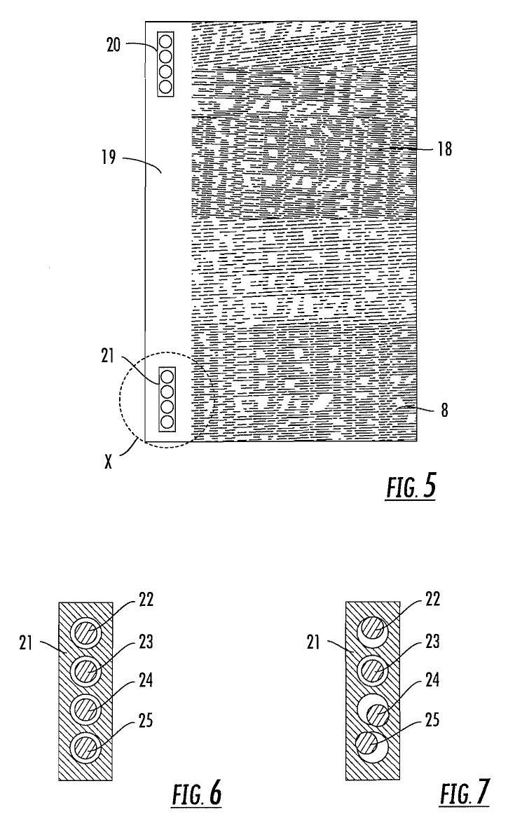

On the engraved roll 5, in addition to the print image, fitting markers are engraved which are transferred accordingly to the inking roll 4, from which they only are transferred to the work piece 8 when it is transported through the printing device 3 laterally off-set. This leads to a test edge 19 next to the print image 18, as shown in FIG. 5.

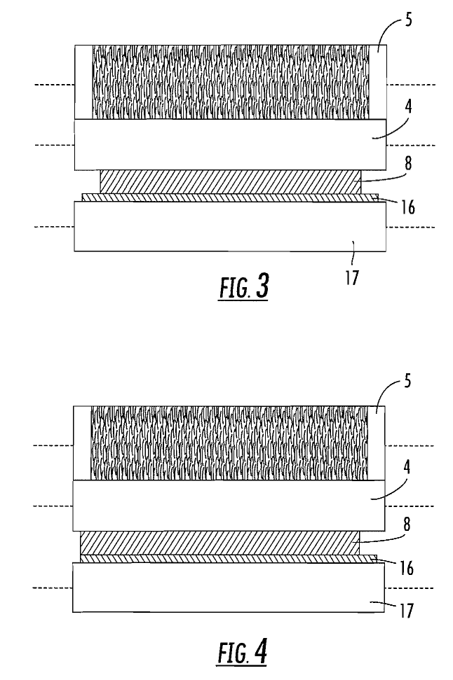

FIGS. 3 and 4 show schematic views of the printing device 3 in the traveling direction so that here, in addition to the inking roll 4 and the engraving roll 5, a counter-roll 17 is also shown, which together with the inking roll 4 forms a printing nip, through which the work piece 8 is guided resting on the conveyer belt 16.

Here, FIG. 3 shows a work piece 8 in a lateral neutral position 14, while FIG. 4 shows the work piece 8 in a laterally off-set test position 15. The inking roll 4, the engraved cylinder 5, and the counter-roll 17 are each provided with an independent drive. In order to increase the precision of the image application on the surface of the work piece as well as to avoid undesired image distortions, the drive of the counter-roll 17 provides a lesser torque than the one of the inking roll 4. This ensures minimum slippage of the rolling of the inking roll 4 on the work piece 8. Additionally, the drives are adjustable in order to create, depending on the image distortions or tolerances in the length of the image detected by the camera 13, a targeted “counter-slippage” to eliminate the distortion and to maintain the length of the print image as good as possible on the level of a 1:1 representation. In order to compensate lateral position tolerances of the print image 18 the printing device 3 may be arranged axially adjustable in its entirety or in individual components, such as, for example, the engraved roll 5. Of course, a correction of a lateral deviation of the position of the print image can occur also by changing the neutral position 14 of the lateral guide 7.

FIG. 5 shows schematically a printed work piece 8, which has been guided laterally off-set in the test position 15 of the exemplary embodiment of the present invention. Accordingly the print image 18 is laterally off-set and a test edge 19 remains free, with in the test edge 19 a first colored signal 20 with four fitting markers as well as a second colored signal 21 with also four fitting markers is applied. Presently a four-color print occurs with a total of four printing devices 3. By comparing the two colored signals 20 and 21 the correct location of the printing image can be detected for each color separately.

In FIGS. 6 and 7 the colored signal 21 is embodied, namely in FIG. 6 with the fitting markers 22, 23, 24, and 25, each of which being exactly located within the predetermined tolerances, while in FIG. 7 the need for correction is indicated. The fitting marker 22 for the first printing device 3 shows a printing image 18 being too short. The fitting marker 23 is inside the predetermined tolerance, so that it can be concluded that the second printing device operates correctly. The fitting marker 24 for the third printing device shows a need for correction both regarding the length of the print image (it is too long) as well as in the lateral position of the print image. The same applies to the fitting marker 25 of the fourth printing device.

The colored signals and/or fitting markers are detected by the camera 13 at the exit of the printing line and evaluated, so that an automatic correction of the respective printing devices carried out via the control system affects the subsequent work pieces 8 via the adjustment of the drives and the other adjustment possibilities within the scope of a trend correction. Thus, a control loop and/or a system of control loops develops, which during the continuous production independently ensures the adherence to very narrow tolerances for the position of the print image and the length of the print image even in full-surface printing of work pieces 8.

### LIST OF REFERENCE CHARACTERS

1 diagonal roll conveyer
2 belt conveyer
3 printing device
4 inking roll
5 engraved roll
6 roll conveyer
7 lateral guide
8 work piece
9 conveyer belt
10 rolls
11 forward motion sensor
12 sensor of the image position
13 camera
14 neutral position (of 7)
15 test position (of 7)
16 transportation conveyer
17 counter-roll
18 print image
19 test edge
20 colored signal (first)
21 colored signal (second)
22 fitting marker (first)
23 fitting marker (second)
24 fitting marker (third)
25 fitting marker (fourth)

1. A device for printing flat work pieces, comprising a transportation device (1, 6, 9, 16) for the work pieces (8) and at least one printing device (3), in which an inking roll (4) rolls on the work pieces (8) transported through the printing device (3) and thereby applies a print image (18) on a surface of the work piece, with the transportation device (1, 6, 9, 16) being provided with a lateral guide (7) for the work pieces (8), the lateral guide (7) includes sections that are independently adjustable between a neutral position (14) and a test position (15) that is offset from the neutral position.

2. A device according to claim 1, wherein a control system for the lateral guide (7) is provided, which adjusts it each of the sections as necessary so that a designated work piece (8) in a series of the work pieces (8) located on the transportation device (1, 6, 9, 16) successively contacts the sections of the lateral guide (7) which have been adjusted into the test position (15), and thus are transported through the printing device (3) laterally off-set, while the other ones of the work pieces (8) of the series contact the lateral guide (7) with the sections thereof being in the neutral position (14).

3. A device according to claim 2, wherein the printing device (3) prints markings (20, 21) for a location of the print image on an edge (19) of the surface of the work piece off-set in the test position, laterally protruding beyond the neutral position (14) of the lateral guide (7) of the work piece (8).

4. A device according to claim 3, wherein a detection device (13) is provided downstream of the printing device (3) to detect the markings (20, 21) of the location of the print image.

5. A device according to claim 4, wherein the detection device (13) is in communication with the control system which adjusts the neutral position (14) of the lateral guide (7) in order to correct a lateral displacement of the print image.

6. A device according to claim 4, wherein the detection device (13) is in communication with the control system which displaces the printing device (3), the printing cylinder (5) or both perpendicular to a travel direction of the work pieces (8) in order to correct lateral displacements of the print image.

7. A device according to claim 4, wherein the detection device (13) comprises an optical sensor or a digital camera.

8. A device according to claim 7, wherein the detection device (13) is arranged so that a height of the detection device above the work pieces can be adjusted.

9. A device according to claim 8, wherein a control panel is provided for controlling at least one of the drive of the printing device (3), the transportation device (1, 6, 16), or the lateral guides (7), and cooperates with the detection device (13) to accelerate or slow the drive of the printing device (3), the transportation device (1, 9, 16), or both according to a position of the markers (20, 21) of the print image or changes the neutral position (14) of the lateral guide (7) in order to correct the displacement of the print image and/or the distortions in length of the print image.

10. A device according to claim 9, wherein at least one cylinder (4, 5) of the print device (3) for forming the print can be axially displaced for laterally adjusting the print image (18), with the control system initiating an axial displacement according to a position of the markers (20, 21) of the print image.

11. A device according to claim 1, further comprising a transportation element that transfers a force component to the work piece (8) perpendicular to a transportation direction and the lateral guide (7).
